(19) United States
(12) Patent Application Publication
(10) Pub. No.: US 2026/0059366 A1
(43) Pub. Date: Feb. 26, 2026

(54) PERFORMANCE INDICATION SENDING METHOD, RECEIVING METHOD AND SENDING APPARATUS, DEVICE, AND STORAGE MEDIUM

(71) Applicant: BEIJING XIAOMI MOBILE SOFTWARE CO., LTD., Beijing (CN)

(72) Inventors: Mingju LI, Beijing (CN); Qin MU, Beijing (CN)

(73) Assignee: BEIJING XIAOMI MOBILE SOFTWARE CO., LTD., Beijing (CN)

(21) Appl. No.: 19/102,971

(22) PCT Filed: Aug. 12, 2022
(86) PCT No.: PCT/CN2022/112199

§ 371 Date: Feb. 11, 2025

(51) Int. Cl. H04W 24/10; H04W 24/02

(52) U.S. Cl. CPC H04W 24/10; H04W 24/02

(57) ABSTRACT

A method for sending a performance indication, performed by a terminal, includes: sending the performance indication to a network device, wherein the performance indication is configured to indicate that a performance of a model is higher than a threshold, and the model is used for beam prediction.

### CROSS-REFERENCE TO RELATED APPLICATION

This application is U.S. national phase application of International Application PCT/CN2022/112199, filed Aug. 12, 2022, the entire disclosure of which is incorporated herein by reference.

### FIELD

The present disclosure relates to the field of mobile communications, and more particularly, to a method and apparatus for sending a performance indication, a method and apparatus for receiving a performance indication, a device and a storage medium.

### BACKGROUND

In a mobile communication system, a network device configures a reference signal resource set for beam measurement for a terminal, so that the terminal can perform the beam measurement based on the reference signal resource set and report the measured beam qualities to the network device.

In the related art, in order to reduce the measurement amount to be performed by the terminal, beam prediction can be performed by an artificial intelligence (AI) model. For example, beam qualities of a part of beams obtained by measurement are input into the AI model to make the AI model predict beam qualities of other beams; or beam qualities obtained by measurement in a historical duration are input into the AI model to make the AI model predict beam qualities of beams in the future.

However, there are applicable conditions for the AI model, and the performance of the model is unstable.

### SUMMARY

According to a first aspect of the present disclosure, there is provided a method for sending a performance indication, which is performed by a terminal, and includes: sending the performance indication to a network device. The performance indication is configured to indicate that a performance of a model is higher than a threshold, and the model is used for beam prediction.

According to a second aspect of the present disclosure, there is provided a method for receiving a performance indication, which is performed by a network device, and includes: receiving the performance indication sent by a terminal. The performance indication is configured to indicate that a performance of a model is higher than a threshold, and the model is used for beam prediction.

According to a third aspect of the present disclosure, there is provided an apparatus for sending a performance indication, which includes: a sending module, configured to send the performance indication to a network device. The performance indication is configured to indicate that a performance of a model is higher than a threshold, and the model is used for beam prediction.

According to a fourth aspect of the present disclosure, there is provided an apparatus for receiving a performance indication, which includes: a receiving module, configured to receive the performance indication sent by a terminal. The performance indication is configured to indicate that a performance of a model is higher than a threshold, and the model is used for beam prediction.

According to a fifth aspect of the present disclosure, there is provided a terminal, which includes: a processor; a transceiver connected to the processor; and a memory for storing instructions executable by the processor. The processor is configured to load and execute executable instructions to implement the method for sending a performance indication as described in the above aspect.

According to a sixth aspect of the present disclosure, there is provided a network device, which includes: a processor; a transceiver connected to the processor; and a memory for storing instructions executable by the processor. The processor is configured to load and execute executable instructions to implement the method for receiving a performance indication as described in the above aspect.

According to a seventh aspect of the present disclosure, there is provided a communication system, which includes: a terminal, configured to perform the method for sending a performance indication as described in the first aspect above; and a network device, configured to perform the method for receiving a performance indication as described in the second aspect above.

According to an eighth aspect of the present disclosure, there is provided a computer-readable storage medium having stored therein executable program codes that, when loaded and executed by a processor, cause the method for sending a performance indication or the method for receiving a performance indication as described in the above aspects.

According to a ninth aspect of the present disclosure, there is provided a chip. The chip includes a programmable logic circuit and/or program instructions, and is configured to perform the method for sending a performance indication or the method for receiving a performance indication as described in the above aspects when it is run on a terminal or a network device.

According to a tenth aspect of the present disclosure, there is provided a computer program product that, when executed by a processor of a terminal or a network device, causes the method for sending a performance indication or the method for receiving a performance indication as described in the above aspects to be implemented.

### BRIEF DESCRIPTION OF THE DRAWINGS

Drawings to be used in the description of some embodiments will be briefly introduced below. Apparently, the drawings in the following description are only related to some embodiments of the present disclosure.

FIG. 1 shows a block diagram of a communication system according to an example embodiment of the present disclosure;

FIG. 2 shows a flowchart of a method for sending a performance indication according to an example embodiment of the present disclosure;

FIG. 3 shows a schematic diagram of beam directions according to an example embodiment of the present disclosure;

FIG. 4 shows a flowchart of a performance monitoring method according to an example embodiment of the present disclosure;

FIG. 5 shows a schematic diagram of a beam prediction method according to an example embodiment of the present disclosure;

FIG. 6 shows a schematic diagram of another beam prediction method according to an example embodiment of the present disclosure;

FIG. 7 shows a flowchart of a performance monitoring method according to an example embodiment of the present disclosure;

FIG. 8 shows a flowchart of a model updating method according to an example embodiment of the present disclosure;

FIG. 9 shows a flowchart of a method for sending a performance indication according to an example embodiment of the present disclosure;

FIG. 10 shows a flowchart of a method for receiving a performance indication according to an example embodiment of the present disclosure;

FIG. 11 shows a block diagram of an apparatus for sending a performance indication according to an example embodiment of the present disclosure;

FIG. 12 shows a block diagram of another apparatus for sending a performance indication according to an example embodiment of the present disclosure;

FIG. 13 shows a block diagram of an apparatus for receiving a performance indication according to an example embodiment of the present disclosure;

FIG. 14 shows a block diagram of another apparatus for receiving a performance indication according to an example embodiment of the present disclosure; and

FIG. 15 shows a schematic structural diagram of a communication device according to an example embodiment of the present disclosure.

In order to make the purposes, technical solutions and advantages of the present disclosure clearer, embodiments of the present disclosure will be further described in detail below with reference to the accompanying drawings.

Reference will now be made in detail to examples embodiments, examples of which are illustrated in the accompanying drawings. The following description refers to the accompanying drawings in which the same numbers in different drawings represent the same or similar elements unless otherwise represented. The implementations described in the following illustrative embodiments do not represent all implementations consistent with the present disclosure. Instead, they are merely examples of apparatuses and methods consistent with some aspects of the present disclosure as recited in the appended claims.

Terms used in the present disclosure are for the purpose of describing specific embodiments, but should not be construed to limit the present disclosure. As used in embodiments of the present disclosure and the appended claims, “a/an”, “said” and “the” in singular forms are intended to include plural forms, unless clearly indicated in the context otherwise. It should also be understood that, the term “and/or” used herein represents and contains any one or any possible combinations of one or more associated items listed.

It should be understood that, although terms such as “first,” “second” and “third” may be used in embodiments of the present disclosure for describing various information, these information should not be limited by these terms. These terms are only used for distinguishing information of the same type from each other. For example, first information may also be referred to as second information, and similarly, the second information may also be referred to as the first information, without departing from the scope of embodiments of the present disclosure. For example, depending on the context, the term “if” as used herein may be construed to mean “when” or “upon” or “in response to determining”.

It should be noted that information (including but not limited to user equipment information, user personal information, etc.), data (including but not limited to data used for analysis, stored data, displayed data, etc.) and signals involved in the present disclosure all are authorized by users or fully authorized by individual parties, and the collection, use and processing of relevant data need to comply with relevant laws, regulations and standards of countries and regions involved.

First, applicable scenarios of the present disclosure will be explained.

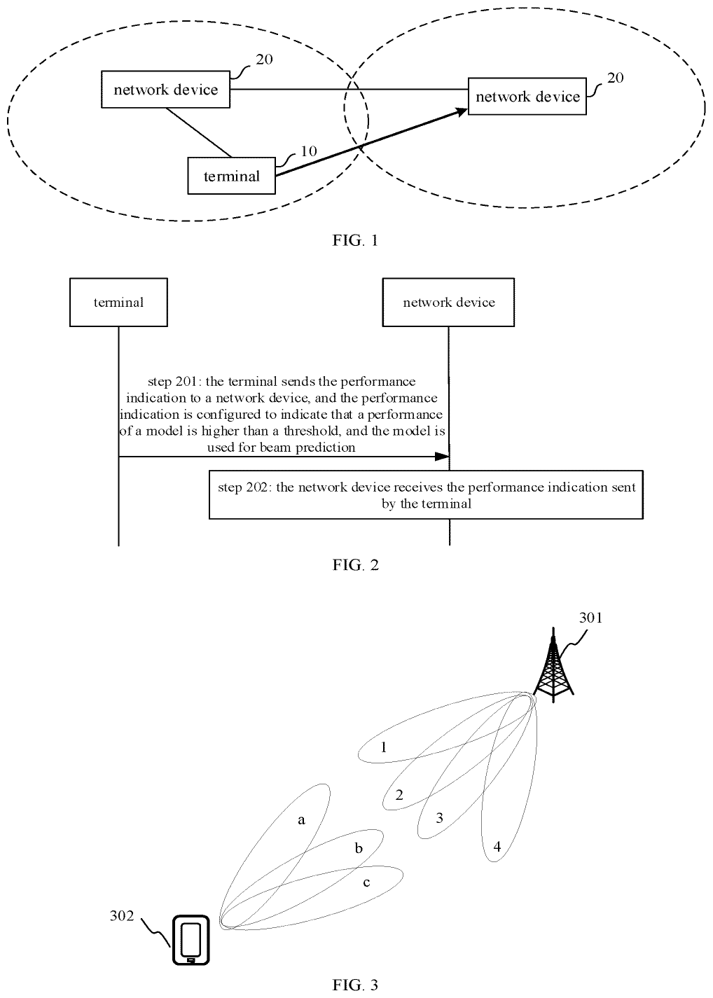

FIG. 1 shows a block diagram of a communication system according to an example embodiment of the present disclosure, and the communication system may include: a terminal 10 and a network device 20.

Usually, there are multiple terminals 10, and one or more terminals 10 are distributed in a cell managed by each network device 20. The terminals 10 may include various devices with wireless communication functions, like handheld devices, vehicle-mounted devices, wearable devices, computing devices or other processing devices connected to wireless modems, as well as various forms of user equipment (UE), mobile stations (MSs) and so on. For convenience of description, in embodiments of the present disclosure, the above-mentioned devices are collectively referred to as terminals.

The network device 20 is a device deployed in an access network to provide wireless communication functions for the terminal 10. For convenience of description, in embodiments of the present disclosure, the above-mentioned devices that provide wireless communication functions for the terminals 10 are collectively referred to as network devices. The network device 20 and the terminal 10 can establish a connection therebetween through an air interface, so that communication, including signaling and data interaction, can be performed through the connection. There may exist multiple network devices 20, and two adjacent network devices 20 may also communicate with each other in a wired or wireless manner. The terminal 10 may send a beam report to different network devices 20, that is, the terminal 10 establishes connections with different network devices 20.

The network device 20 may include various forms of macro base stations, micro base stations, relay stations, access points, etc. A device with the function of the network device may be named differently in systems using different wireless access technologies, for example, it is called gNodeB or gNB in a 5G new radio (NR) system. With the evolution of communication technology, the name of the “network device” may change.

The “5G NR system” in embodiments of the present disclosure may also be called a 5G system or an NR system, and those skilled in the art can understand its meaning. The technical solutions described in embodiments of the present disclosure are applicable to the 5G NR system, and are applicable to an evolution system subsequent to the 5G NR system.

FIG. 2 shows a flowchart of a method for sending a performance indication according to an example embodiment of the present disclosure. The method may be applied to for example the terminal and network device as shown in FIG. 1, and the method includes at least part of the following contents.

In step 201, the terminal sends the performance indication to a network device, and the performance indication is configured to indicate that a performance of a model is higher than a threshold, and the model is used for beam prediction.

In step 202, the network device receives the performance indication sent by the terminal.

In embodiments of the present disclosure, there may exist differences in the performance of the model for the beam prediction in different environments, which means that the accuracy of the model for the beam prediction is unstable. The terminal may send the performance indication to the network device, so that the network device determines that the performance of the model is higher than the threshold according to the performance indication, and it may also indicate that the accuracy of the model for the beam prediction is high.

In some embodiments, the model is at least one of: an AI model, a mathematical model, or a machine learning model, which is not specifically limited in the present disclosure.

The beam prediction in embodiments of the present disclosure refers to predicting a beam identifier and/or a beam quality of a beam with the best beam quality among a plurality of beams. For example, the network device will configure a reference signal set for beam measurement. Individual reference signals in the reference signal set correspond to different transmission beams at the network device side. The terminal measures each reference signal in the reference signal set, and reports identifiers and respective beam qualities of X reference signals with strong beam quality in the reference signal set. The beam quality includes a Layer1-reference signal received power (L1-RSRP) and/or Layer1-signal to interference plus noise ratio (L1-SINR).

If the number of beam pairs whose beam qualities are needed to be obtained by the terminal is M*N (where M is the number of beams sent by the network device, and N is the number of beams received by the terminal), with the assistance of the AI model, the terminal may only need to measure the beam qualities of P beam pairs in the M*N beam pairs, where P is less than M*N; and then input the measured beam qualities of the P beam pairs into the AI model, and the AI model can output identifiers and beam qualities of at least X optimal beam pairs in the M*N beam pairs. One beam pair includes a transmission beam of the network device and a reception beam of the terminal side, and X is a positive integer. The transmission beam of the network device corresponds to a reference signal ID.

For example, as shown in FIG. 3, beams of the network device 301 include Beam 1, Beam 2, Beam 3 and Beam 4, and the reception beams of the terminal 302 include Beam a, Beam b and Beam c. In this case, beam pairs whose beam qualities are needed to be obtained by the terminal include a total of 12 beam pairs, i.e., “Beam 1-Beam a”, “Beam 1-Beam b”, “Beam 1-Beam c”, “Beam 2-Beam a”, “Beam 2-Beam b”, “Beam 2-Beam c”, “Beam 3-Beam a”, “Beam 3-Beam b”, “Beam 3-Beam c”, “Beam 4-Beam a”, “Beam 4-Beam b” and “Beam 4-Beam c”. The terminal may only needs to measure the beam qualities of “Beam 1-Beam a”, “Beam 2-Beam b”, “Beam 3-Beam c” and “Beam 4-Beam c”, and input the measured beam qualities into the AI model; and the AI model can output the identifiers and/or beam qualities of at least X optimal beam pairs among all the 12 beam pairs, where X is a positive integer.

In a possible embodiment, the terminal measures the L1-RSRP and/or L1-SINR of the reference signal. The reference signal includes at least one of: a synchronization signal/PBCH block (SSB), a channel state information-reference signal (CSI-RS), or a sounding reference signal (SRS).

In a possible embodiment, the terminal determines a channel and/or a beam of a reference signal transmitted by the network device according to a transmission configuration indication state (TCI state). TCI state includes at least one Quasi Co-Location (QCL) type. The QCL type includes at least one of: Type A, Type B, Type C, or Type D. Type A, Type B and Type C include at least one of parameters related to Doppler frequency shift, Doppler spread, average delay and delay spread. Type D is reception parameter information, which may also be called a beam.

It should be noted that in embodiments of the present disclosure, the steps performed by the terminal may independently form a new embodiment, and the steps performed by the network device may independently form a new embodiment, which are not limited in embodiments of the present disclosure.

In the solutions according to embodiments of the present disclosure, the terminal notifies the network device that the performance of the model meets the requirement through the performance indication, which ensures the accuracy of the model performance reported by the terminal, thereby improving the accuracy of subsequent model-based beam prediction.

On the basis of the performance indication reported by the terminal in embodiments shown in FIG. 2, the content included in the performance indication will be described below.

In some embodiments, the performance indication includes at least one of the following information.

### (1) Indication of Good Performance of the Model

Optionally, a specific SR is defined for use when the performance of the model becomes better. That is, the SR indicates that the performance of the AI model becomes better. Alternatively, a specific MAC CE is defined for use when the performance of the model becomes better. That is, the MAC CE indicates that performance of the model becomes better. Alternatively, a bit is used to indicate the performance of the AI model, for example, a value of “1” is used to indicate that the performance of the AI model is higher than the threshold, which means that the performance of the AI model is good; and a value of “0” is used to indicate that the performance of the AI model is lower than the threshold, which means that the performance of the AI model is poor.

### (2) A Performance Index Value of the Model

Optionally, the performance index value refers to a numerical value of a performance index of the AI model.

### (3) At Least One of a Model Identifier, a Version Identifier, a Parameter Configuration Identifier or Parameter Configuration of the Model

Optionally, the model identifier is used to indicate the AI model from multiple AI models. For example, model identifiers include identifiers corresponding to models with different functions. For example, AI model #1 is used for CSI compression, AI model #2 is used for beam prediction, or AI model #3 is used for positioning prediction.

Optionally, the version identifier is used to indicate the model version from multiple versions of the AI model. For example, if the AI model includes four model versions, “00”, “01”, “10” and “11” may be used to indicate these four model versions, respectively.

Optionally, the parameter configuration identifier is used to indicate a parameter configuration from multiple sets of parameter configurations of the AI model.

Optionally, the parameter configuration is used to represent a network parameter of the AI model.

### (4) At Least One of a Model Identifier, a Version Identifier, a Parameter Configuration Identifier or Parameter Configuration of a Recommended Model

Optionally, the recommended model refers to an updated AI model recommended by the terminal.

In embodiments of the present disclosure, parameters are carried in the performance indication to indicate that the performance of the model is higher than the threshold, so that the network device determines that the performance of the model is higher than the threshold according to the parameters included in the performance indication, which improves the accuracy of the performance of the model reported by the terminal, thereby improving the accuracy of subsequent model-based beam prediction.

The embodiments shown in FIG. 2 are described with reference to examples where the terminal reports the performance indication to the network device. In the following, a condition for the terminal to report the performance indication will be described.

In some embodiments, in a case where the terminal determines that the performance index of the model is higher than the threshold, the terminal sends the performance indication to the network device.

That is, the steps in embodiments of the present disclosure may replace the above step 201.

In embodiments of the present disclosure, the terminal may obtain the performance index of the model, which is used to indicate the performance of the model. The terminal may determine whether the performance index of the model is higher than the threshold, so that the terminal sends the performance indication to the network device, in the case where the terminal determines that the performance index of the model is higher than the threshold.

In the solutions according to embodiments of the present disclosure, the terminal determines whether the performance index of the model is higher than the threshold to determine whether to report the performance indication to the network device, thereby improving the accuracy of the performance of the model reported by the terminal, and improving the accuracy of subsequent model-based beam prediction.

In some embodiments, the performance index includes at least one of the followings:
(1) Prediction accuracy: a probability that reference signal identifiers of N strongest reference signals predicted by the AI model contain a reference signal identifier of an actual strongest reference signal. The reference signal identifier (i.e., identifier of a reference signal) includes at least one of: an SSB identifier, a CSI-RS identifier or an SRS identifier. The strongest reference signal refers to a reference signal with the largest L1-RSRP or L1-SINR. N is a positive integer. The reference signal identifiers of N strongest reference signals predicted by the AI model refer to reference signal identifiers of N reference signals predicted by the AI model to have beam qualities ranked the top N. Optionally, the reference signal identifier of the actual strongest reference signal is a reference signal identifier of a reference signal whose beam quality ranks first among the measured beam qualities of all reference signals.
(2) Average L1-RSRP difference: a difference between an actual L1-RSRP corresponding to a reference signal identifier of a strongest reference signal predicted by the AI model and an actual L1-RSRP corresponding to a reference signal identifier of an actual strongest reference signal. If the reference signal identifier of the strongest reference signal predicted by the AI model is the same as the reference signal identifier of the actual strongest reference signal, the L1-RSRP difference is 0. The average L1-RSRP difference may be obtained based on a prediction result of the AI model in a single prediction, or based on an average of prediction results of the AI model in multiple predictions.
(3) Average L1-SINR difference: a difference between an actual L1-SINR corresponding to a reference signal identifier of a strongest reference signal predicted by the AI model and an actual L1-SINR corresponding to a reference signal identifier of an actual strongest reference signal. If the reference signal identifier of the strongest reference signal predicted by the AI model is the same as the reference signal identifier of the actual strongest reference signal, the L1-SINR difference is 0. The average L1-SINR difference may be obtained based on a prediction result of the AI model in a single prediction, or based on an average of prediction results of the AI model in multiple predictions.
(4) Target L1-RSRP difference corresponding to a first percentage on a cumulative distribution function (CDF) curve of L1-RSRP differences

In an embodiment, the CDF curve of L1-RSRP differences is a CDF curve obtained according to L1-RSRP differences in the prediction results of the AI model in multiple predictions as described in the above (2). That is, the L1-RSRP difference only includes the difference between the actual L1-RSRP corresponding to the reference signal identifier of the strongest reference signal predicted by the AI model and the actual L1-RSRP corresponding to the reference signal identifier of the actual strongest reference signal. In another embodiment, the L1-RSRP difference refers to a difference between a predicted L1-RSRP corresponding to each reference signal identifier predicted by the AI model in at least one prediction and an actual L1-RSRP corresponding to the respective actual reference signal identifier. That is, the AI model needs to output the L1-RSRP corresponding to each reference signal identifier. The first percentage is any percentage on the CDF curve of L1-RSRP differences. Optionally, the first percentage is pre-configured by an access network device, for example, the first percentage is 5%, 50%, or 95%.
(5) Target L1-SINR difference corresponding to a second percentage on a CDF curve of L1-SINR differences

In an embodiment, the CDF curve of L1-SINR differences is a CDF curve obtained according to L1-SINR differences in the prediction results of the model in multiple predictions as described in the above (3). That is, the L1-SINR difference only includes the difference between the actual L1-SINR corresponding to the reference signal identifier of the strongest reference signal predicted by the AI model and the actual L1-SINR corresponding to the reference signal identifier of the actual strongest reference signal. In another embodiment, the L1-SINR difference refers to a difference between a predicted L1-SINR corresponding to each reference signal identifier predicted by the AI model in at least one prediction and an actual L1-SINR corresponding to the respective actual reference signal identifier. That is, the AI model needs to output the L1-SINR corresponding to each reference signal identifier. The second percentage is any percentage on the CDF curve of L1-SINR differences. Optionally, the second percentage is pre-configured by an access network device, for example, the second percentage is 5%, 50%, or 95%.
(6) Average UE throughput difference

Based on the difference between the actual L1-RSRP corresponding to the reference signal identifier of the strongest reference signal predicted by the AI model and the actual L1-RSRP corresponding to the reference signal identifier of the actual strongest reference signal, SINRs corresponding to these two reference signal identifiers are obtained respectively, Shannon capacities corresponding to these two reference signal identifiers are calculated respectively, and a difference between the Shannon capacities corresponding to these two reference signal identifiers is the performance index. The performance index may be obtained according to a prediction result of the AI model in a single prediction, or may be obtained according to prediction results of the AI model in multiple predictions.

It should be noted that, the above embodiments are described with reference to examples where the terminal determines that the performance index of the model is higher than the threshold. The following will explain how the terminal obtains the performance index of the model.

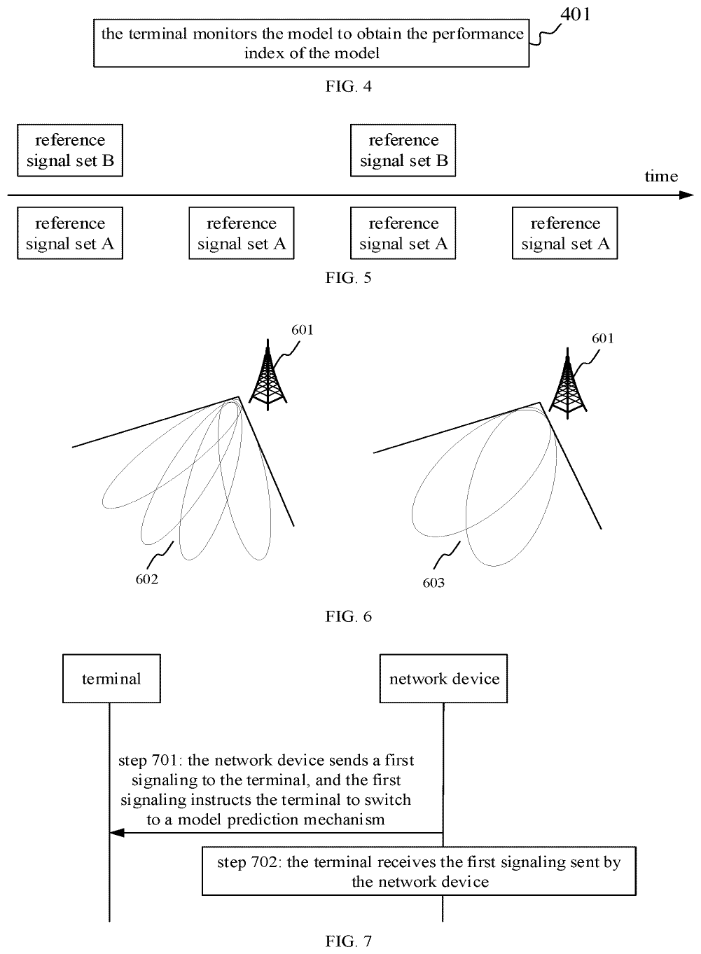

FIG. 4 shows a flowchart of a performance monitoring method according to an example embodiment of the present disclosure. The method may be applied to for example the terminal as shown in FIG. 1, and the method includes at least part of the following contents.

In step 401, the terminal monitors the model to obtain the performance index of the model.

In embodiments of the present disclosure, the terminal monitors the model so as to obtain the performance index of the model, and then based on the obtained performance index, the terminal determines whether it is higher than the threshold.

In some embodiments, the terminal may determine the performance index according to at least one prediction result output by the model within a first duration. The first duration may be indicated by the network device to the terminal, or the first duration may be determined based on a default value. For example, assuming that the first duration is 1 second, and if the AI model outputs three prediction results within 1 second, the performance index of the AI model will be determined according to these three prediction results.

In some embodiments, the terminal may determine the performance index according to N1 prediction results output by the model, where N1 is a positive integer. N1 may be indicated by the network device to the terminal, or N1 may also be determined based on a default value. For example, if N1=3, three prediction results continuously output by the AI model are obtained, and the performance index is determined based on these three prediction results. For another example, if N1=3, and the AI model outputs 10 prediction results within a period of time, 3 prediction results may be randomly selected therefrom to determine the performance index, or 3 prediction results may be selected therefrom according to a preset rule to determine the performance index.

In solutions according to embodiments of the present disclosure, there is provided a solution for the terminal to monitor the model to obtain the performance index of the model, which improves the accuracy of the performance of the model reported by the terminal, and further improves the accuracy of subsequent model-based beam prediction.

In some embodiments, at the present stage, the terminal uses traditional methods to perform the beam measurement, and the terminal will also perform the beam prediction based on the model, so that the terminal determines whether the performance index of the model is higher than the threshold and further determines the performance of the model, according to the beam quality obtained by the beam measurement and the beam quality obtained by the beam prediction.

Optionally, if the terminal measures beam qualities of a reference signal set B and inputs the measured beam qualities into the AI model to predict a beam ID and/or beam quality of an optimal beam in a reference signal set A, where the beam quality is L1-RSRP and/or L1-SINR. The number of optimal beams is one or more.

In a case, the terminal needs to monitor the performance of the AI model, the terminal requires the network device to periodically send reference signals in reference signal set A, and then the terminal measures the beam ID and/or L1-RSRP and/or L1-SINR of an optimal beam of the reference signals in reference signal set A, determines the reference signal set B from the reference signal set A, inputs L1-RSRPs and/or L1-SINRs of the reference signals in the reference signal set B into the AI model to predict beam qualities of the reference signal set A or an identifier and/or a beam quality of an optimal reference signal in the reference signal set A, compares the identifier of the predicted strongest reference signal with the identifier of the actual strongest reference signal or obtains other performance indexes mentioned above, and compares the performance index with a performance index threshold to determine whether it needs to report the performance indication to the network device.

For example, as shown in FIG. 5, the terminal receives the reference signals in the reference signal set B, and also receives the reference signals in the reference signal set A. It can be seen from FIG. 5 that the terminal can monitor the performance of the model in a case where the terminal receives both the reference signal set A and the reference signal set B.

In some embodiments, the terminal inputs L1-RSRPs and/or L1-SINRs of reference signals in a first set within a second duration into the AI model to obtain a beam ID and/or absolute value(s) and/or relative relationships(s) of an L1-RSRP and/or an L1-SINR of an optimal beam within a third duration from reference signals in a second set, where the first set is a subset of the second set. The first set and the second set may be the same set, or the first set is a proper subset of the second set. Optionally, the second duration is a historical duration, and the third duration is a duration after the second duration. For example, the second set includes 32 reference signals within the third duration, and the first set includes 8 reference signals within the second duration, then the terminal predicts beam qualities of the 32 reference signals within the third duration by using the AI model according to beam qualities of the 8 reference signals within the second duration.

It should be noted that in embodiments of the present disclosure, in addition to predicting the beam ID and/or the L1-RSRP and/or the L1-SINR of the optimal beam of the reference signals in the second set by using the AI model, the terminal also performs the beam measurement on the reference signals in the second set to obtain a beam ID and/or an L1-RSRP and/or an L1-SINR of a measured optimal beam, determines the performance index of the AI model according to the beam ID and/or the L1-RSRP and/or the L1-SINR of the measured optimal beam and the beam ID and/or the L1-RSRP and/or the L1-SINR of the predicted optimal beam, and further determines whether the performance index of the AI model is higher than the threshold.

In some embodiments, the terminal inputs L1-RSRPs and/or L1-SINRs of reference signals in a third set within a second duration into the AI model to obtain a beam ID and/or absolute value(s) and/or relative relationships(s) of an L1-RSRP and/or an L1-SINR of an optimal beam within a third duration from reference signals in a fourth set, a beam width of the reference signal in the third set is greater than a beam width of the reference signal in the fourth set, and a beam directional range of each reference signal in the third set covers a beam directional range of a plurality of reference signals in the fourth set. For example, the fourth set includes 32 reference signals, each reference signal corresponds to a beam directional range, and these 32 reference signals cover a directional range of 120 degrees. The third set includes N reference signals, and these reference signals also cover a directional range of 120 degrees. It may also be considered that 32/N reference signals in the fourth set have a relationship of QCL Type D with the respective reference signal in the third set. For example, as shown in FIG. 6, the fourth set 602 provided by the network device 601 includes 4 reference signals, and these 4 reference signals cover a beam directional range of 120 degrees; and the third set 603 provided by the network device 601 includes 2 reference signals, and a beam directional range covered by these 2 reference signals is the same as the beam directional range of 120 degrees covered by the 4 reference signals mentioned above.

It should be noted that in embodiments of the present disclosure, in addition to predicting the beam ID and/or the L1-RSRP and/or the L1-SINR of the optimal beam of the reference signals in the fourth set by using the AI model, the terminal also performs beam measurement on the reference signals in the fourth set to obtain a beam ID and/or an L1-RSRP and/or an L1-SINR of a measured optimal beam, determines the performance index of the AI model according to the beam ID and/or the L1-RSRP and/or the L1-SINR of the measured optimal beam and the beam ID and/or the L1-RSRP and/or the L1-SINR of the predicted optimal beam, and further determines whether the performance index of the AI model is higher than the threshold.

Optionally, the second duration and the third duration are within the same period, and the period is used for a transmission period of reference signals for beam measurement or used for a reporting period of a beam measurement report.

Optionally, the second duration and the third duration are not in the same period, for example, the second duration is a historical duration, and the third duration is a future duration. That is, it may be understood as that the beam quality measured within a historical duration is used to predict the beam quality within a future duration.

On the basis of the above embodiments, the terminal also needs to determine the threshold corresponding to the performance index of the model. Specific solutions for the terminal to determine the threshold include any of the following cases.

Case 1: the threshold corresponding to the performance index of the model is determined according to indication information of the network device.

In embodiments of the present disclosure, the network device may send the indication information to the terminal. After receiving the indication information sent by the network device, the terminal may determine the threshold corresponding to the performance index of the model.

In some embodiments, the indication information includes at least one of: downlink control information (DCI), a medium access control control element (MACCE), or radio resource control (RRC).

Case 2: the threshold corresponding to the performance index of the model is determined according to a default value.

In embodiments of the present disclosure, the default value is specified by a communication protocol or pre-determined in other ways, which is not limited in embodiments of the present disclosure.

It should be noted that embodiments of the present disclosure are described with reference to examples where the terminal sends the performance indication to the network device. In the following, how the terminal sends the performance indication will be explained.

In some embodiments, the method for the terminal to send the performance indication to the network device includes any of the following methods.
(1) The terminal reports the performance indication to an access network device via a PUCCH or a PUSCH.
(2) The terminal reports the performance indication to an access network device via information for carrying channel state information (CSI). The CSI is used in a feedback method for feeding back at least one of: a precoding matrix indication (PMI), a rank indication (RI), a layer indication (LI), a channel state information-reference signal resource indication (CSI-RS resource Indication, CRI), an L1-RSRP or an L1-SINR.
(3) The terminal reports the performance indication to an access network device via an uplink medium access control control unit (UL MAC CE) and/or a scheduling request (SR).
(4) The terminal reports the performance indication to the network device through a time-frequency domain resource or a preamble for dedicated random access sent via a random access channel.

Embodiments of the present disclosure provide several ways for reporting the performance indication to the network device, which expands the ways for reporting the performance indication, and improves the diversity for reporting the performance indication.

Embodiments shown in FIG. 2 explain how the terminal reports the performance indication to the network device. In another embodiment, the network device also instructs the terminal to switch to a model prediction mechanism. In the following, instructing manners of the network device will be explained. FIG. 7 shows a flowchart of a performance monitoring method according to an example embodiment of the present disclosure, the method may be applied to for example the terminal and network device as shown in FIG. 1. The method includes at least part of the following contents.

In step 701, the network device sends a first signaling to the terminal, and the first signaling instructs the terminal to switch to a model prediction mechanism.

In step 702, the terminal receives the first signaling sent by the network device.

In embodiments of the present disclosure, when the network device determines that it is necessary to switch to the model prediction mechanism, the network device will send the first signaling to the terminal to instruct the terminal to switch to the model prediction mechanism.

The model prediction mechanism may also be understood as an AI prediction mechanism, i.e., a mechanism that uses a model to perform the beam prediction, which is not limited in embodiments of the present disclosure.

In some embodiments, the network device receives the performance indication sent by the terminal and determines that the performance of the model is higher than the threshold, which means that the model may be used for the beam prediction in this case. Therefore, the network device sends the first signaling to the terminal to instruct the terminal to switch to the model prediction mechanism.

In some embodiments, the first signaling indicates a model identifier of the model. The first signaling is carried in at least one of: RRC, MAC CE, or DCI. That is, the first signaling indicates switching to the model prediction mechanism through at least one of RRC, MAC CE or DCI.

The model identifier indicates at least one of: a model function, a model parameter or a model version of the model. That is, the model identifier may indicate the model function, the model parameter or the model version. In addition, the model identifier may also indicate the model function and the model parameter, or indicate the model function and the model version, or indicate the model parameter and the model version. In addition, the model identifier may also indicate the model function, the model parameter and the model version.

Optionally, the network device provides a corresponding relationship between model identifiers and model parameters to the terminal via an RRC signaling in advance. The MAC CE or DCI is used to indicate the model identifier, so that the terminal determines the model parameter according to the first signaling carried in the MAC CE or DCI.

Optionally, the network device provides a corresponding relationship between model identifiers and the model parameters to the terminal via an RRC signaling in advance. The MAC CE is used to activate a part of the model identifiers, and the DCI is used to activate one of the part of the model identifiers, so that the terminal determines the model parameter according to the model identifier.

It should be noted that in the case where the model identifier indicates the model function, it also means that model identifiers include model identifiers corresponding to models with different functions. For example, models with different functions include a model for CSI compression, a model for beam prediction, or a model for positioning prediction.

In the case where the model identifier indicates the model version or the model parameter, it also means that model identifiers include model identifiers corresponding to different versions or different parameters.

In some embodiments, if the model identifier indicates the model version, the model identifier in embodiments of the present disclosure may also be replaced by a model version identifier, which means that different model version identifiers indicate different versions of model. Alternatively, if the model identifier indicates the model parameter, the model identifier in embodiments of the present disclosure may also be replaced by a model parameter identifier, which means that different model parameter identifiers indicate models with different parameter configurations.

In the solutions according to embodiments of the present disclosure, the network device instructs the terminal to switch to the model prediction mechanism through the first signaling, so that the terminal performs the beam prediction based on the model, reducing energy consumption of the terminal.

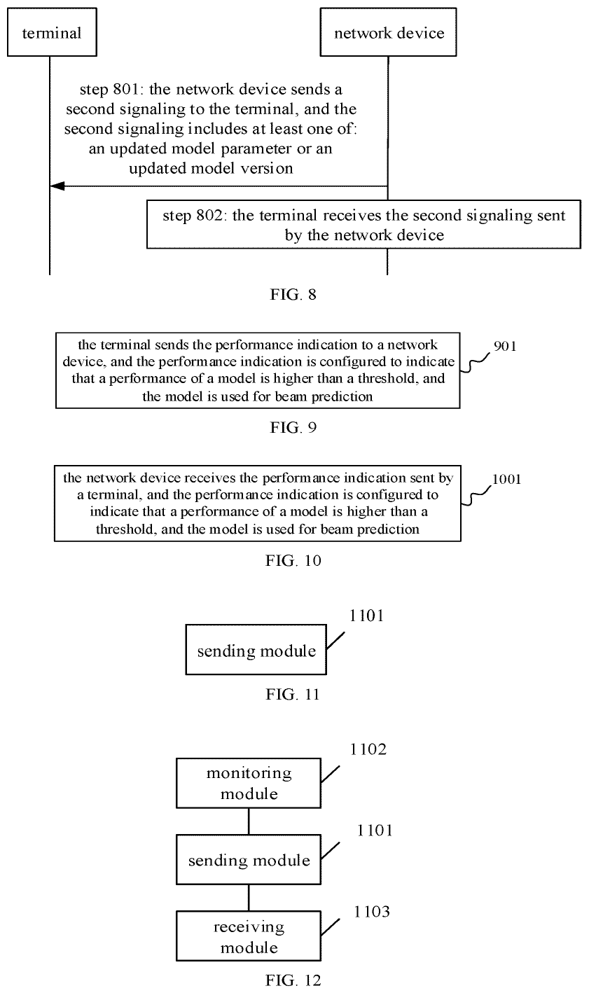

It should be noted that embodiments of the present disclosure are described with reference to examples where the network device instructs to switch to the model prediction mechanism through the first signaling. In another embodiment, the network device also updates the parameter or version of the model. FIG. 8 shows a flowchart of a model updating method according to an example embodiment of the present disclosure, the method may be applied to for example the terminal and the network device as shown in FIG. 1, and includes at least part of the following contents.

In step 801, the network device sends a second signaling to the terminal, and the second signaling includes at least one of: an updated model parameter or an updated model version.

In step 802, the terminal receives the second signaling sent by the network device.

In embodiments of the present disclosure, if the network device needs to update the parameter or version of the model, it may send to the terminal the second signaling including at least one of: the updated model parameter or the updated model version. After receiving the second signaling, the terminal may determine that the parameter or version of the model needs to be updated.

In the solutions according to embodiments of the present disclosure, the network device may update the model parameter or model version of the model of the terminal, so that the terminal can use the updated model to improve the accuracy of the model-based beam prediction.

It should be noted that the above embodiments may be split into new embodiments, or combined with other embodiments to form new embodiments. The present disclosure does not limit the combination of embodiments.

FIG. 9 shows a flowchart of a method for sending a performance indication according to an example embodiment of the present disclosure. The method may be applied to for example the terminal as shown in FIG. 1, and the method includes at least part of the following contents.

In step 901, the terminal sends the performance indication to a network device, and the performance indication is configured to indicate that a performance of a model is higher than a threshold, and the model is used for beam prediction.

In embodiments of the present disclosure, there may exist differences in the performance of the model for the beam prediction in different environments, which means that the accuracy of the model for the beam prediction is unstable. The terminal may send the performance indication to the network device, so that the network device determines that the performance of the model is higher than the threshold according to the performance indication, and it may also indicate that the accuracy of the model for the beam prediction is high.

In some embodiments, the model is at least one of: an AI model, a mathematical model, or a machine learning model, which is not specifically limited in the present disclosure.

The beam prediction in embodiments of the present disclosure refers to predicting a beam identifier and/or a beam quality of a beam with the best beam quality among a plurality of beams. For example, the network device will configure a reference signal set for beam measurement. Individual reference signals in the reference signal set correspond to different transmission beams at the network device side. The terminal measures each reference signal in the reference signal set, and reports identifiers and respective beam qualities of X reference signals with strong beam quality in the reference signal set. The beam quality includes a Layer1-reference signal received power (L1-RSRP) and/or Layer1-signal to interference plus noise ratio (L1-SINR).

If the number of beam pairs whose beam qualities are needed to be obtained by the terminal is M*N (where M is the number of beams sent by the network device, and N is the number of beams received by the terminal), with the assistance of the AI model, the terminal may only need to measure the beam qualities of P beam pairs in the M*N beam pairs, where P is less than M*N; and then input the measured beam qualities of the P beam pairs into the AI model, and the AI model can output identifiers and beam qualities of at least X optimal beam pairs in the M*N beam pairs. One beam pair includes a transmission beam of the network device and a reception beam of the terminal side, and X is a positive integer. The transmission beam of the network device corresponds to a reference signal ID.

For example, as shown in FIG. 3, beams of the network device 301 include Beam 1, Beam 2, Beam 3 and Beam 4, and the reception beams of the terminal 302 include Beam a, Beam b and Beam c. In this case, beam pairs whose beam qualities are needed to be obtained by the terminal include a total of 12 beam pairs, i.e., “Beam 1-Beam a”, “Beam 1-Beam b”, “Beam 1-Beam c”, “Beam 2-Beam a”, “Beam 2-Beam b”, “Beam 2-Beam c”, “Beam 3-Beam a”, “Beam 3-Beam b”, “Beam 3-Beam c”, “Beam 4-Beam a”, “Beam 4-Beam b” and “Beam 4-Beam c”. The terminal may only needs to measure the beam qualities of “Beam 1-Beam a”, “Beam 2-Beam b”, “Beam 3-Beam c” and “Beam 4-Beam c”, and input the measured beam qualities into the AI model; and the AI model can output the identifiers and/or beam qualities of at least X optimal beam pairs among all the 12 beam pairs, where X is a positive integer.

In a possible embodiment, the terminal measures the L1-RSRP and/or L1-SINR of the reference signal. The reference signal includes at least one of: a synchronization signal/PBCH block (SSB), a channel state information-reference signal (CSI-RS), or a sounding reference signal (SRS).

In a possible embodiment, the terminal determines a channel and/or a beam of a reference signal transmitted by the network device according to a transmission configuration indication state (TCI state). TCI state includes at least one Quasi Co-Location (QCL) type. The QCL type includes at least one of: Type A, Type B, Type C, or Type D. Type A, Type B and Type C include at least one of parameters related to Doppler frequency shift, Doppler spread, average delay and delay spread. Type D is reception parameter information, which may also be called a beam.

It should be noted that in embodiments of the present disclosure, the steps performed by the terminal may independently form a new embodiment, and the steps performed by the network device may independently form a new embodiment, which are not limited in embodiments of the present disclosure.

In the solutions according to embodiments of the present disclosure, the terminal notifies the network device that the performance of the model meets the requirement through the performance indication, which ensures the accuracy of the model performance reported by the terminal, thereby improving the accuracy of subsequent model-based beam prediction.

On the basis of the performance indication reported by the terminal in embodiments shown in FIG. 9, the content included in the performance indication will be described below.

In some embodiments, the performance indication includes at least one of the following information:

### (1) Indication of Good Performance of the Model

Optionally, a specific SR is defined for use when the performance of the model becomes better. That is, the SR indicates that the performance of the AI model becomes better. Alternatively, a specific MAC CE is defined for use when the performance of the model becomes better. That is, the MAC CE indicates that performance of the model becomes better. Alternatively, a bit is used to indicate the performance of the AI model, for example, a value of “1” is used to indicate that the performance of the AI model is higher than the threshold, which means that the performance of the AI model is good; and a value of “0” is used to indicate that the performance of the AI model is lower than the threshold, which means that the performance of the AI model is poor.

### (2) A Performance Index Value of the Model

Optionally, the performance index value refers to a numerical value of a performance index of the AI model.

### (3) At Least One of a Model Identifier, a Version Identifier, a Parameter Configuration Identifier or Parameter Configuration of the Model

Optionally, the model identifier is used to indicate the AI model from multiple AI models. For example, model identifiers include identifiers corresponding to models with different functions. For example, AI model #1 is used for CSI compression, AI model #2 is used for beam prediction, or AI model #3 is used for positioning prediction.

Optionally, the version identifier is used to indicate the model version from multiple versions of the AI model. For example, if the AI model includes four model versions, “00”, “01”, “10” and “11” may be used to indicate these four model versions, respectively.

Optionally, the parameter configuration identifier is used to indicate a parameter configuration from multiple sets of parameter configurations of the AI model.

Optionally, the parameter configuration is used to represent a network parameter of the AI model.

### (4) At Least One of a Model Identifier, a Version Identifier, a Parameter Configuration Identifier or Parameter Configuration of a Recommended Model

Optionally, the recommended model refers to an updated AI model recommended by the terminal.

In embodiments of the present disclosure, parameters are carried in the performance indication to indicate that the performance of the model is higher than the threshold, so that the network device determines that the performance of the model is higher than the threshold according to the parameters included in the performance indication, which improves the accuracy of the performance of the model reported by the terminal, thereby improving the accuracy of subsequent model-based beam prediction.

The embodiments shown in FIG. 9 are described with reference to examples where the terminal reports the performance indication to the network device. In the following, a condition for the terminal to report the performance indication will be described.

In some embodiments, in a case where the terminal determines that the performance index of the model is higher than the threshold, the terminal sends the performance indication to the network device.

That is, the steps in embodiments of the present disclosure may replace the above step 901.

In embodiments of the present disclosure, the terminal may obtain the performance index of the model, which is used to indicate the performance of the model. The terminal may determine whether the performance index of the model is higher than the threshold, so that the terminal sends the performance indication to the network device, in the case where the terminal determines that the performance index of the model is higher than the threshold.

In the solutions according to embodiments of the present disclosure, the terminal determines whether the performance index of the model is higher than the threshold to determine whether to report the performance indication to the network device, thereby improving the accuracy of the performance of the model reported by the terminal, and improving the accuracy of subsequent model-based beam prediction.

In some embodiments, the performance index includes at least one of the followings.
(1) Prediction accuracy: a probability that reference signal identifiers of N strongest reference signals predicted by the AI model contain a reference signal identifier of an actual strongest reference signal. The reference signal identifier (i.e., identifier of a reference signal) includes at least one of: an SSB identifier, a CSI-RS identifier or an SRS identifier. The strongest reference signal refers to a reference signal with the largest L1-RSRP or L1-SINR. N is a positive integer. The reference signal identifiers of N strongest reference signals predicted by the AI model refer to reference signal identifiers of N reference signals predicted by the AI model to have beam qualities ranked the top N. Optionally, the reference signal identifier of the actual strongest reference signal is a reference signal identifier of a reference signal whose beam quality ranks first among the measured beam qualities of all reference signals.
(2) Average L1-RSRP difference: a difference between an actual L1-RSRP corresponding to a reference signal identifier of a strongest reference signal predicted by the AI model and an actual L1-RSRP corresponding to a reference signal identifier of an actual strongest reference signal. If the reference signal identifier of the strongest reference signal predicted by the AI model is the same as the reference signal identifier of the actual strongest reference signal, the L1-RSRP difference is 0. The average L1-RSRP difference may be obtained based on a prediction result of the AI model in a single prediction, or based on an average of prediction results of the AI model in multiple predictions.
(3) Average L1-SINR difference: a difference between an actual L1-SINR corresponding to a reference signal identifier of a strongest reference signal predicted by the AI model and an actual L1-SINR corresponding to a reference signal identifier of an actual strongest reference signal. If the reference signal identifier of the strongest reference signal predicted by the AI model is the same as the reference signal identifier of the actual strongest reference signal, the L1-SINR difference is 0. The average L1-SINR difference may be obtained based on a prediction result of the AI model in a single prediction, or based on an average of prediction results of the AI model in multiple predictions.
(4) Target L1-RSRP difference corresponding to a first percentage on a cumulative distribution function (CDF) curve of L1-RSRP differences

In an embodiment, the CDF curve of L1-RSRP differences is a CDF curve obtained according to L1-RSRP differences in the prediction results of the AI model in multiple predictions as described in the above (2). That is, the L1-RSRP difference only includes the difference between the actual L1-RSRP corresponding to the reference signal identifier of the strongest reference signal predicted by the AI model and the actual L1-RSRP corresponding to the reference signal identifier of the actual strongest reference signal. In another embodiment, the L1-RSRP difference refers to a difference between a predicted L1-RSRP corresponding to each reference signal identifier predicted by the AI model in at least one prediction and an actual L1-RSRP corresponding to the respective actual reference signal identifier. That is, the AI model needs to output the L1-RSRP corresponding to each reference signal identifier. The first percentage is any percentage on the CDF curve of L1-RSRP differences. Optionally, the first percentage is pre-configured by an access network device, for example, the first percentage is 5%, 50%, or 95%.
(5) Target L1-SINR difference corresponding to a second percentage on a CDF curve of L1-SINR differences

In an embodiment, the CDF curve of L1-SINR differences is a CDF curve obtained according to L1-SINR differences in the prediction results of the model in multiple predictions as described in the above (3). That is, the L1-SINR difference only includes the difference between the actual L1-SINR corresponding to the reference signal identifier of the strongest reference signal predicted by the AI model and the actual L1-SINR corresponding to the reference signal identifier of the actual strongest reference signal. In another embodiment, the L1-SINR difference refers to a difference between a predicted L1-SINR corresponding to each reference signal identifier predicted by the AI model in at least one prediction and an actual L1-SINR corresponding to the respective actual reference signal identifier. That is, the AI model needs to output the L1-SINR corresponding to each reference signal identifier. The second percentage is any percentage on the CDF curve of L1-SINR differences. Optionally, the second percentage is pre-configured by an access network device, for example, the second percentage is 5%, 50%, or 95%.
(6) Average UE throughput difference

Based on the difference between the actual L1-RSRP corresponding to the reference signal identifier of the strongest reference signal predicted by the AI model and the actual L1-RSRP corresponding to the reference signal identifier of the actual strongest reference signal, SINRs corresponding to these two reference signal identifiers are obtained respectively, Shannon capacities corresponding to these two reference signal identifiers are calculated respectively, and a difference between the Shannon capacities corresponding to these two reference signal identifiers is the performance index. The performance index may be obtained according to a prediction result of the AI model in a single prediction, or may be obtained according to prediction results of the AI model in multiple predictions.

It should be noted that, the above embodiments are described with reference to examples where the terminal determines that the performance index of the model is higher than the threshold. The following will explain how the terminal obtains the performance index of the model.

In some embodiments, the terminal monitors the model to obtain the performance index of the model.

In embodiments of the present disclosure, the terminal monitors the model so as to obtain the performance index of the model, and then based on the obtained performance index, the terminal determines whether it is higher than the threshold.

In some embodiments, the terminal may determine the performance index according to at least one prediction result output by the model within a first duration. The first duration may be indicated by the network device to the terminal, or the first duration may be determined based on a default value. For example, assuming that the first duration is 1 second, and if the AI model outputs three prediction results within 1 second, the performance index of the AI model will be determined according to these three prediction results.

In some embodiments, the terminal may determine the performance index according to N1 prediction results output by the model, where N1 is a positive integer. N1 may be indicated by the network device to the terminal, or N1 may also be determined based on a default value. For example, if N1=3, three prediction results continuously output by the AI model are obtained, and the performance index is determined based on these three prediction results. For another example, if N1=3, and the AI model outputs 10 prediction results within a period of time, 3 prediction results may be randomly selected therefrom to determine the performance index, or 3 prediction results may be selected therefrom according to a preset rule to determine the performance index.

In solutions according to embodiments of the present disclosure, there is provided a solution for the terminal to monitor the model to obtain the performance index of the model, which improves the accuracy of the performance of the model reported by the terminal, and further improves the accuracy of subsequent model-based beam prediction.

In some embodiments, at the present stage, the terminal uses traditional methods to perform the beam measurement, and the terminal will also perform the beam prediction based on the model, so that the terminal determines whether the performance index of the model is higher than the threshold and further determines the performance of the model, according to the beam quality obtained by the beam measurement and the beam quality obtained by the beam prediction.

Optionally, if the terminal measures beam qualities of a reference signal set B and inputs the measured beam qualities into the AI model to predict a beam ID and/or beam quality of an optimal beam in a reference signal set A, where the beam quality is L1-RSRP and/or L1-SINR.

In a case, the terminal needs to monitor the performance of the AI model, the terminal requires the network device to periodically send reference signals in reference signal set A, and then the terminal measures the beam ID and/or L1-RSRP and/or L1-SINR of an optimal beam of the reference signals in reference signal set A, determines the reference signal set B from the reference signal set A, inputs L1-RSRPs and/or L1-SINRs of the reference signals in the reference signal set B into the AI model to predict beam qualities of the reference signal set A or an identifier and/or a beam quality of an optimal reference signal in the reference signal set A, compares the identifier of the predicted strongest reference signal with the identifier of the actual strongest reference signal or obtains other performance indexes mentioned above, and compares the performance index with a performance index threshold to determine whether it needs to report the performance indication to the network device.

For example, as shown in FIG. 5, the terminal receives the reference signals in the reference signal set B, and also receives the reference signals in the reference signal set A. It can be seen from FIG. 5 that the terminal can monitor the performance of the model in a case where the terminal receives both the reference signal set A and the reference signal set B.

In some embodiments, the terminal inputs L1-RSRPs and/or L1-SINRs of reference signals in a first set within a second duration into the AI model to obtain a beam ID and/or absolute value(s) and/or relative relationships(s) of an L1-RSRP and/or an L1-SINR of an optimal beam within a third duration from reference signals in a second set, where the first set is a subset of the second set. The first set and the second set may be the same set, or the first set is a proper subset of the second set. Optionally, the second duration is a historical duration, and the third duration is a duration after the second duration. For example, the second set includes 32 reference signals within the third duration, and the first set includes 8 reference signals within the second duration, then the terminal predicts beam qualities of the 32 reference signals within the third duration by using the AI model according to beam qualities of the 8 reference signals within the second duration.

It should be noted that in embodiments of the present disclosure, in addition to predicting the beam ID and/or the L1-RSRP and/or the L1-SINR of the optimal beam of the reference signals in the second set by using the AI model, the terminal also performs the beam measurement on the reference signals in the second set to obtain a beam ID and/or an L1-RSRP and/or an L1-SINR of a measured optimal beam, determines the performance index of the AI model according to the beam ID and/or the L1-RSRP and/or the L1-SINR of the measured optimal beam and the beam ID and/or the L1-RSRP and/or the L1-SINR of the predicted optimal beam, and further determines whether the performance index of the AI model is higher than the threshold.

In some embodiments, the terminal inputs L1-RSRPs and/or L1-SINRs of reference signals in a third set within a second duration into the AI model to obtain a beam ID and/or absolute value(s) and/or relative relationships(s) of an L1-RSRP and/or an L1-SINR of an optimal beam within a third duration from reference signals in a fourth set, a beam width of the reference signal in the third set is greater than a beam width of the reference signal in the fourth set, and a beam directional range of each reference signal in the third set covers a beam directional range of a plurality of reference signals in the fourth set. For example, the fourth set includes 32 reference signals, each reference signal corresponds to a beam directional range, and these 32 reference signals cover a directional range of 120 degrees. The third set includes N reference signals, and these reference signals also cover a directional range of 120 degrees. It may also be considered that 32/N reference signals in the fourth set have a relationship of QCL Type D with the respective reference signal in the third set. For example, as shown in FIG. 6, the fourth set 602 provided by the network device 601 includes 4 reference signals, and these 4 reference signals cover a beam directional range of 120 degrees; and the third set 603 provided by the network device 601 includes 2 reference signals, and a beam directional range covered by these 2 reference signals is the same as the beam directional range of 120 degrees covered by the 4 reference signals mentioned above.

It should be noted that in embodiments of the present disclosure, in addition to predicting the beam ID and/or the L1-RSRP and/or the L1-SINR of the optimal beam of the reference signals in the fourth set by using the AI model, the terminal also performs beam measurement on the reference signals in the fourth set to obtain a beam ID and/or an L1-RSRP and/or an L1-SINR of a measured optimal beam, determines the performance index of the AI model according to the beam ID and/or the L1-RSRP and/or the L1-SINR of the measured optimal beam and the beam ID and/or the L1-RSRP and/or the L1-SINR of the predicted optimal beam, and further determines whether the performance index of the AI model is higher than the threshold.

Optionally, the second duration and the third duration are within the same period, and the period is used for a transmission period of reference signals for beam measurement or used for a reporting period of a beam measurement report.

Optionally, the second duration and the third duration are not in the same period, for example, the second duration is a historical duration, and the third duration is a future duration. That is, it may be understood as that the beam quality measured within a historical duration is used to predict the beam quality within a future duration.

On the basis of the above embodiments, the terminal also needs to determine the threshold corresponding to the performance index of the model. Specific solutions for the terminal to determine the threshold include any of the following cases.

Case 1: the threshold corresponding to the performance index of the model is determined according to indication information of the network device.

In embodiments of the present disclosure, the network device may send the indication information to the terminal. After receiving the indication information sent by the network device, the terminal may determine the threshold corresponding to the performance index of the model.

In some embodiments, the indication information includes at least one of: downlink control information (DCI), a medium access control control element (MACCE), or radio resource control (RRC).

Case 2: the threshold corresponding to the performance index of the model is determined according to a default value.

In embodiments of the present disclosure, the default value is specified by a communication protocol or pre-determined in other ways, which is not limited in embodiments of the present disclosure.

It should be noted that embodiments of the present disclosure are described with reference to examples where the terminal sends the performance indication to the network device. In the following, how the terminal sends the performance indication will be explained.

In some embodiments, the method for the terminal to send the performance indication to the network device includes any of the following methods:
(1) The terminal reports the performance indication to an access network device via a PUCCH or a PUSCH.
(2) The terminal reports the performance indication to an access network device via information for carrying channel state information (CSI). The CSI is used in a feedback method for feeding back at least one of: a precoding matrix indication (PMI), a rank indication (RI), a layer indication (LI), a channel state information-reference signal resource indication (CSI-RS resource Indication, CRI), an L1-RSRP or an L1-SINR.
(3) The terminal reports the performance indication to an access network device via an uplink medium access control control unit (UL MAC CE) and/or a scheduling request (SR).
(4) The terminal reports the performance indication to the network device through a time-frequency domain resource or a preamble for dedicated random access sent via a random access channel.

Embodiments of the present disclosure provide several ways for reporting the performance indication to the network device, which expands the ways for reporting the performance indication, and improves the diversity for reporting the performance indication.

The above embodiments explain how the terminal reports the performance indication to the network device. In another embodiment, the network device also instructs the terminal to switch to a model prediction mechanism. In the following, instructing manners of the network device will be explained. In some embodiments, the terminal receives a first signaling sent by the network device, and the first signaling instructs the terminal to switch to a model prediction mechanism.

In embodiments of the present disclosure, when the network device determines that it is necessary to switch to the model prediction mechanism, the network device will send the first signaling to the terminal to instruct the terminal to switch to the model prediction mechanism.

The model prediction mechanism may also be understood as an AI prediction mechanism, i.e., a mechanism that uses a model to perform the beam prediction, which is not limited in embodiments of the present disclosure.

In some embodiments, the network device receives the performance indication sent by the terminal and determines that the performance of the model is higher than the threshold, which means that the model may be used for the beam prediction in this case. Therefore, the network device sends the first signaling to the terminal to instruct the terminal to switch to the model prediction mechanism.

In some embodiments, the first signaling indicates a model identifier of the model. The first signaling is carried in at least one of: RRC, MAC CE, or DCI. That is, the first signaling indicates switching to the model prediction mechanism through at least one of RRC, MAC CE or DCI.

The model identifier indicates at least one of: a model function, a model parameter or a model version of the model. That is, the model identifier may indicate the model function, the model parameter or the model version. In addition, the model identifier may also indicate the model function and the model parameter, or indicate the model function and the model version, or indicate the model parameter and the model version. In addition, the model identifier may also indicate the model function, the model parameter and the model version.

Optionally, the network device provides a corresponding relationship between model identifiers and model parameters to the terminal via an RRC signaling in advance. The MAC CE or DCI is used to indicate the model identifier, so that the terminal determines the model parameter according to the first signaling carried in the MAC CE or DCI.

Optionally, the network device provides a corresponding relationship between model identifiers and the model parameters to the terminal via an RRC signaling in advance. The MAC CE is used to activate a part of the model identifiers, and the DCI is used to activate one of the part of the model identifiers, so that the terminal determines the model parameter according to the model identifier.

It should be noted that in the case where the model identifier indicates the model function, it also means that model identifiers include model identifiers corresponding to models with different functions. For example, models with different functions include a model for CSI compression, a model for beam prediction, or a model for positioning prediction.

In the case where the model identifier indicates the model version or the model parameter, it also means that model identifiers include model identifiers corresponding to different versions or different parameters.

In some embodiments, if the model identifier indicates the model version, the model identifier in embodiments of the present disclosure may also be replaced by a model version identifier, which means that different model version identifiers indicate different versions of model. Alternatively, if the model identifier indicates the model parameter, the model identifier in embodiments of the present disclosure may also be replaced by a model parameter identifier, which means that different model parameter identifiers indicate models with different parameter configurations.

In the solutions according to embodiments of the present disclosure, the network device instructs the terminal to switch to the model prediction mechanism through the first signaling, so that the terminal performs the beam prediction based on the model, reducing energy consumption of the terminal.

It should be noted that embodiments of the present disclosure are described with reference to examples where the network device instructs to switch to the model prediction mechanism through the first signaling. In another embodiment, the network device also updates the parameter or version of the model. In some embodiments, the terminal receives a second signaling sent by the network device, and the second signaling includes at least one of: an updated model parameter or an updated model version.

In embodiments of the present disclosure, if the network device needs to update the parameter or version of the model, it may send to the terminal the second signaling including at least one of: the updated model parameter or the updated model version. After receiving the second signaling, the terminal may determine that the parameter or version of the model needs to be updated.

In the solutions according to embodiments of the present disclosure, the network device may update the model parameter or model version of the model of the terminal, so that the terminal can use the updated model to improve the accuracy of the model-based beam prediction.

FIG. 10 shows a flowchart of a method for receiving a performance indication according to an example embodiment of the present disclosure. The method may be applied to for example the network device as shown in FIG. 1, and the method includes at least part of the following contents.

In step 1001, the network device receives the performance indication sent by a terminal, and the performance indication is configured to indicate that a performance of a model is higher than a threshold, and the model is used for beam prediction.

In embodiments of the present disclosure, there may exist differences in the performance of the model for the beam prediction in different environments, which means that the accuracy of the model for the beam prediction is unstable. The terminal may send the performance indication to the network device, so that the network device determines that the performance of the model is higher than the threshold according to the performance indication, and it may also indicate that the accuracy of the model for the beam prediction is high.

In some embodiments, the model is at least one of: an AI model, a mathematical model, or a machine learning model, which is not specifically limited in the present disclosure.

The beam prediction in embodiments of the present disclosure refers to predicting a beam identifier and/or a beam quality of a beam with the best beam quality among a plurality of beams. For example, the network device will configure a reference signal set for beam measurement. Individual reference signals in the reference signal set correspond to different transmission beams at the network device side. The terminal measures each reference signal in the reference signal set, and reports identifiers and respective beam qualities of X reference signals with strong beam quality in the reference signal set. The beam quality includes a Layer1-reference signal received power (L1-RSRP) and/or Layer1-signal to interference plus noise ratio (L1-SINR).

If the number of beam pairs whose beam qualities are needed to be obtained by the terminal is M*N (where M is the number of beams sent by the network device, and N is the number of beams received by the terminal), with the assistance of the AI model, the terminal may only need to measure the beam qualities of P beam pairs in the M*N beam pairs, where P is less than M*N; and then input the measured beam qualities of the P beam pairs into the AI model, and the AI model can output identifiers and beam qualities of at least X optimal beam pairs in the M*N beam pairs. One beam pair includes a transmission beam of the network device and a reception beam of the terminal side, and X is a positive integer. The transmission beam of the network device corresponds to a reference signal ID.

For example, as shown in FIG. 3, beams of the network device 301 include Beam 1, Beam 2, Beam 3 and Beam 4, and the reception beams of the terminal 302 include Beam a, Beam b and Beam c. In this case, beam pairs whose beam qualities are needed to be obtained by the terminal include a total of 12 beam pairs, i.e., “Beam 1-Beam a”, “Beam 1-Beam b”, “Beam 1-Beam c”, “Beam 2-Beam a”, “Beam 2-Beam b”, “Beam 2-Beam c”, “Beam 3-Beam a”, “Beam 3-Beam b”, “Beam 3-Beam c”, “Beam 4-Beam a”, “Beam 4-Beam b” and “Beam 4-Beam c”. The terminal may only needs to measure the beam qualities of “Beam 1-Beam a”, “Beam 2-Beam b”, “Beam 3-Beam c” and “Beam 4-Beam c”, and input the measured beam qualities into the AI model; and the AI model can output the identifiers and/or beam qualities of at least X optimal beam pairs among all the 12 beam pairs, where X is a positive integer.

In a possible embodiment, the terminal measures the L1-RSRP and/or L1-SINR of the reference signal. The reference signal includes at least one of: a synchronization signal/PBCH block (SSB), a channel state information-reference signal (CSI-RS), or a sounding reference signal (SRS).

In a possible embodiment, the terminal determines a channel and/or a beam of a reference signal transmitted by the network device according to a transmission configuration indication state (TCI state). TCI state includes at least one Quasi Co-Location (QCL) type. The QCL type includes at least one of: Type A, Type B, Type C, or Type D. Type A, Type B and Type C include at least one of parameters related to Doppler frequency shift, Doppler spread, average delay and delay spread. Type D is reception parameter information, which may also be called a beam.

It should be noted that in embodiments of the present disclosure, the steps performed by the terminal may independently form a new embodiment, and the steps performed by the network device may independently form a new embodiment, which are not limited in embodiments of the present disclosure.

In the solutions according to embodiments of the present disclosure, the terminal notifies the network device that the performance of the model meets the requirement through the performance indication, which ensures the accuracy of the model performance reported by the terminal, thereby improving the accuracy of subsequent model-based beam prediction.

On the basis of the performance indication reported by the terminal in embodiments shown in FIG. 10, the content included in the performance indication will be described below.

In some embodiments, the performance indication includes at least one of the following information:

### (1) Indication of Good Performance of the Model

Optionally, a specific SR is defined for use when the performance of the model becomes better. That is, the SR indicates that the performance of the AI model becomes better. Alternatively, a specific MAC CE is defined for use when the performance of the model becomes better. That is, the MAC CE indicates that performance of the model becomes better. Alternatively, a bit is used to indicate the performance of the AI model, for example, a value of “1” is used to indicate that the performance of the AI model is higher than the threshold, which means that the performance of the AI model is good; and a value of “0” is used to indicate that the performance of the AI model is lower than the threshold, which means that the performance of the AI model is poor.

### (2) A Performance Index Value of the Model

Optionally, the performance index value refers to a numerical value of a performance index of the AI model.

### (3) At Least One of a Model Identifier, a Version Identifier, a Parameter Configuration Identifier or Parameter Configuration of the Model

Optionally, the model identifier is used to indicate the AI model from multiple AI models. For example, model identifiers include identifiers corresponding to models with different functions. For example, AI model #1 is used for CSI compression, AI model #2 is used for beam prediction, or AI model #3 is used for positioning prediction.

Optionally, the version identifier is used to indicate the model version from multiple versions of the AI model. For example, if the AI model includes four model versions, “00”, “01”, “10” and “11” may be used to indicate these four model versions, respectively.

Optionally, the parameter configuration identifier is used to indicate a parameter configuration from multiple sets of parameter configurations of the AI model.

Optionally, the parameter configuration is used to represent a network parameter of the AI model.

### (4) At Least One of a Model Identifier, A Version Identifier, a Parameter Configuration Identifier or Parameter Configuration of a Recommended Model

Optionally, the recommended model refers to an updated AI model recommended by the terminal.

In embodiments of the present disclosure, parameters are carried in the performance indication to indicate that the performance of the model is higher than the threshold, so that the network device determines that the performance of the model is higher than the threshold according to the parameters included in the performance indication, which improves the accuracy of the performance of the model reported by the terminal, thereby improving the accuracy of subsequent model-based beam prediction.

The embodiments shown in FIG. 10 are described with reference to examples where the terminal reports the performance indication to the network device. In the following, a condition for the terminal to report the performance indication will be described.

In some embodiments, in a case where the terminal determines that the performance index of the model is higher than the threshold, the terminal sends the performance indication to the network device.

That is, the steps in embodiments of the present disclosure may replace the above step 201.

In embodiments of the present disclosure, the terminal may obtain the performance index of the model, which is used to indicate the performance of the model. The terminal may determine whether the performance index of the model is higher than the threshold, so that the terminal sends the performance indication to the network device, in the case where the terminal determines that the performance index of the model is higher than the threshold.

In the solutions according to embodiments of the present disclosure, the terminal determines whether the performance index of the model is higher than the threshold to determine whether to report the performance indication to the network device, thereby improving the accuracy of the performance of the model reported by the terminal, and improving the accuracy of subsequent model-based beam prediction.

In some embodiments, the performance index includes at least one of the followings:
(1) Prediction accuracy: a probability that reference signal identifiers of N strongest reference signals predicted by the AI model contain a reference signal identifier of an actual strongest reference signal. The reference signal identifier (i.e., identifier of a reference signal) includes at least one of: an SSB identifier, a CSI-RS identifier or an SRS identifier. The strongest reference signal refers to a reference signal with the largest L1-RSRP or L1-SINR. N is a positive integer. The reference signal identifiers of N strongest reference signals predicted by the AI model refer to reference signal identifiers of N reference signals predicted by the AI model to have beam qualities ranked the top N. Optionally, the reference signal identifier of the actual strongest reference signal is a reference signal identifier of a reference signal whose beam quality ranks first among the measured beam qualities of all reference signals.
(2) Average L1-RSRP difference: a difference between an actual L1-RSRP corresponding to a reference signal identifier of a strongest reference signal predicted by the AI model and an actual L1-RSRP corresponding to a reference signal identifier of an actual strongest reference signal. If the reference signal identifier of the strongest reference signal predicted by the AI model is the same as the reference signal identifier of the actual strongest reference signal, the L1-RSRP difference is 0. The average L1-RSRP difference may be obtained based on a prediction result of the AI model in a single prediction, or based on an average of prediction results of the AI model in multiple predictions.
(3) Average L1-SINR difference: a difference between an actual L1-SINR corresponding to a reference signal identifier of a strongest reference signal predicted by the AI model and an actual L1-SINR corresponding to a reference signal identifier of an actual strongest reference signal. If the reference signal identifier of the strongest reference signal predicted by the AI model is the same as the reference signal identifier of the actual strongest reference signal, the L1-SINR difference is 0. The average L1-SINR difference may be obtained based on a prediction result of the AI model in a single prediction, or based on an average of prediction results of the AI model in multiple predictions.
(4) Target L1-RSRP difference corresponding to a first percentage on a cumulative distribution function (CDF) curve of L1-RSRP differences

In an embodiment, the CDF curve of L1-RSRP differences is a CDF curve obtained according to L1-RSRP differences in the prediction results of the AI model in multiple predictions as described in the above (2). That is, the L1-RSRP difference only includes the difference between the actual L1-RSRP corresponding to the reference signal identifier of the strongest reference signal predicted by the AI model and the actual L1-RSRP corresponding to the reference signal identifier of the actual strongest reference signal. In another embodiment, the L1-RSRP difference refers to a difference between a predicted L1-RSRP corresponding to each reference signal identifier predicted by the AI model in at least one prediction and an actual L1-RSRP corresponding to the respective actual reference signal identifier. That is, the AI model needs to output the L1-RSRP corresponding to each reference signal identifier. The first percentage is any percentage on the CDF curve of L1-RSRP differences. Optionally, the first percentage is pre-configured by an access network device, for example, the first percentage is 5%, 50%, or 95%.
(5) Target L1-SINR difference corresponding to a second percentage on a CDF curve of L1-SINR differences

In an embodiment, the CDF curve of L1-SINR differences is a CDF curve obtained according to L1-SINR differences in the prediction results of the model in multiple predictions as described in the above (3). That is, the L1-SINR difference only includes the difference between the actual L1-SINR corresponding to the reference signal identifier of the strongest reference signal predicted by the AI model and the actual L1-SINR corresponding to the reference signal identifier of the actual strongest reference signal. In another embodiment, the L1-SINR difference refers to a difference between a predicted L1-SINR corresponding to each reference signal identifier predicted by the AI model in at least one prediction and an actual L1-SINR corresponding to the respective actual reference signal identifier. That is, the AI model needs to output the L1-SINR corresponding to each reference signal identifier. The second percentage is any percentage on the CDF curve of L1-SINR differences. Optionally, the second percentage is pre-configured by an access network device, for example, the second percentage is 5%, 50%, or 95%.
(6) Average UE throughput difference

Based on the difference between the actual L1-RSRP corresponding to the reference signal identifier of the strongest reference signal predicted by the AI model and the actual L1-RSRP corresponding to the reference signal identifier of the actual strongest reference signal, SINRs corresponding to these two reference signal identifiers are obtained respectively, Shannon capacities corresponding to these two reference signal identifiers are calculated respectively, and a difference between the Shannon capacities corresponding to these two reference signal identifiers is the performance index. The performance index may be obtained according to a prediction result of the AI model in a single prediction, or may be obtained according to prediction results of the AI model in multiple predictions.

On the basis of the above embodiments, the terminal also needs to determine the threshold corresponding to the performance index of the model. Specific solutions for the terminal to determine the threshold include any of the following cases.

Case 1: the threshold corresponding to the performance index of the model is determined according to indication information of the network device.

In embodiments of the present disclosure, the network device may send the indication information to the terminal. After receiving the indication information sent by the network device, the terminal may determine the threshold corresponding to the performance index of the model.

In some embodiments, the indication information includes at least one of: downlink control information (DCI), a medium access control control element (MACCE), or radio resource control (RRC).

Case 2: the threshold corresponding to the performance index of the model is determined according to a default value.

In embodiments of the present disclosure, the default value is specified by a communication protocol or pre-determined in other ways, which is not limited in embodiments of the present disclosure.

It should be noted that embodiments of the present disclosure are described with reference to examples where the terminal sends the performance indication to the network device. In the following, how the terminal sends the performance indication will be explained.

In some embodiments, the method for the terminal to send the performance indication to the network device includes any of the following methods:
(1) The terminal reports the performance indication to an access network device via a PUCCH or a PUSCH.
(2) The terminal reports the performance indication to an access network device via information for carrying channel state information (CSI). The CSI is used in a feedback method for feeding back at least one of: a precoding matrix indication (PMI), a rank indication (RI), a layer indication (LI), a channel state information-reference signal resource indication (CSI-RS resource Indication, CRI), an L1-RSRP or an L1-SINR.
(3) The terminal reports the performance indication to an access network device via an uplink medium access control control unit (UL MAC CE) and/or a scheduling request (SR).
(4) The terminal reports the performance indication to the network device through a time-frequency domain resource or a preamble for dedicated random access sent via a random access channel.

Embodiments of the present disclosure provide several ways for reporting the performance indication to the network device, which expands the ways for reporting the performance indication, and improves the diversity for reporting the performance indication.

Embodiments shown in FIG. 10 explain how the terminal reports the performance indication to the network device. In another embodiment, the network device also instructs the terminal to switch to a model prediction mechanism. In the following, instructing manners of the network device will be explained. In some embodiments, the network device sends a first signaling to the terminal, and the first signaling instructs the terminal to switch to a model prediction mechanism.

In embodiments of the present disclosure, when the network device determines that it is necessary to switch to the model prediction mechanism, the network device will send the first signaling to the terminal to instruct the terminal to switch to the model prediction mechanism.

The model prediction mechanism may also be understood as an AI prediction mechanism, i.e., a mechanism that uses a model to perform the beam prediction, which is not limited in embodiments of the present disclosure.

In some embodiments, the network device receives the performance indication sent by the terminal and determines that the performance of the model is higher than the threshold, which means that the model may be used for the beam prediction in this case. Therefore, the network device sends the first signaling to the terminal to instruct the terminal to switch to the model prediction mechanism.

In some embodiments, the first signaling indicates a model identifier of the model. The first signaling is carried in at least one of: RRC, MAC CE, or DCI. That is, the first signaling indicates switching to the model prediction mechanism through at least one of RRC, MAC CE or DCI.

The model identifier indicates at least one of: a model function, a model parameter or a model version of the model. That is, the model identifier may indicate the model function, the model parameter or the model version. In addition, the model identifier may also indicate the model function and the model parameter, or indicate the model function and the model version, or indicate the model parameter and the model version. In addition, the model identifier may also indicate the model function, the model parameter and the model version.

Optionally, the network device provides a corresponding relationship between model identifiers and model parameters to the terminal via an RRC signaling in advance. The MAC CE or DCI is used to indicate the model identifier, so that the terminal determines the model parameter according to the first signaling carried in the MAC CE or DCI.

Optionally, the network device provides a corresponding relationship between model identifiers and the model parameters to the terminal via an RRC signaling in advance. The MAC CE is used to activate a part of the model identifiers, and the DCI is used to activate one of the part of the model identifiers, so that the terminal determines the model parameter according to the model identifier.

It should be noted that in the case where the model identifier indicates the model function, it also means that model identifiers include model identifiers corresponding to models with different functions. For example, models with different functions include a model for CSI compression, a model for beam prediction, or a model for positioning prediction.

In the case where the model identifier indicates the model version or the model parameter, it also means that model identifiers include model identifiers corresponding to different versions or different parameters.

In some embodiments, if the model identifier indicates the model version, the model identifier in embodiments of the present disclosure may also be replaced by a model version identifier, which means that different model version identifiers indicate different versions of model. Alternatively, if the model identifier indicates the model parameter, the model identifier in embodiments of the present disclosure may also be replaced by a model parameter identifier, which means that different model parameter identifiers indicate models with different parameter configurations.

In the solutions according to embodiments of the present disclosure, the network device instructs the terminal to switch to the model prediction mechanism through the first signaling, so that the terminal performs the beam prediction based on the model, reducing energy consumption of the terminal.

It should be noted that embodiments of the present disclosure are described with reference to examples where the network device instructs to switch to the model prediction mechanism through the first signaling. In another embodiment, the network device also updates the parameter or version of the model. In some embodiments, the network device needs a second signaling to the terminal, and the second signaling includes at least one of: an updated model parameter or an updated model version.

In embodiments of the present disclosure, if the network device needs to update the parameter or version of the model, it may send to the terminal the second signaling including at least one of: the updated model parameter or the updated model version. After receiving the second signaling, the terminal may determine that the parameter or version of the model needs to be updated.

In the solutions according to embodiments of the present disclosure, the network device may update the model parameter or model version of the model of the terminal, so that the terminal can use the updated model to improve the accuracy of the model-based beam prediction.

FIG. 11 shows a block diagram of an apparatus for sending a performance indication according to an example embodiment of the present disclosure, referring to FIG. 11, the apparatus includes a sending module 1101. The sending module 1101 is configured to send the performance indication to a network device, and the performance indication is configured to indicate that a performance of a model is higher than a threshold, and the model is used for beam prediction.

In some embodiments, the performance indication includes at least one of:
an indication of good performance of the model;
a performance index value of the model;
at least one of a model identifier, a version identifier, a parameter configuration identifier or parameter configuration of the model; or
at least one of a model identifier, a version identifier, a parameter configuration identifier or parameter configuration of a recommended model.

In some embodiments, the sending module is further configured to send the performance indication to the network device, in a case where it is determined that a performance index of the model is higher than the threshold.

In some embodiments, the performance index includes at least one of:
a prediction accuracy;
an average Layer1-reference signal received power (L1-RSRP) difference;
an average Layer1-signal to interference plus noise ratio (L1-SINR) difference;
a target L1-RSRP difference corresponding to a first percentage on a cumulative distribution function (CDF) curve of L1-RSRP differences;
a target L1-SINR difference corresponding to a second percentage on a CDF curve of L1-SINR differences; or
an average UE throughput difference.

In some embodiments, referring to FIG. 12, the apparatus further includes a monitoring module 1102. The monitoring module 1102 is configured to monitor the model to obtain the performance index of the model.

In some embodiments, the monitoring module 1102 is further configured to: determine the performance index according to at least one prediction result output by the model within a first duration; or determine the performance index according to N1 prediction results output by the model, where N1 is a positive integer.

In some embodiments, the threshold corresponding to the performance index of the model is determined according to indication information of the network device or a default value.

In some embodiments, referring to FIG. 12, the apparatus further includes a receiving module 1103. The receiving module 1103 is configured to receive the indication information sent by the network device, and the indication information includes at least one of: downlink control information (DCI), medium access control control element (MAC CE), or radio resource control (RRC).

In some embodiments, the sending module 1101 is configured to:
report the performance indication to the network device via a physical uplink control channel (PUCCH) or a physical uplink shared channel (PUSCH);
report the performance indication to the network device via information for carrying channel state information (CSI);
report the performance indication to the network device via an uplink medium access control control unit (UL MAC CE) and/or a scheduling request (SR); or report the performance indication to the network device through a time-frequency domain resource or a preamble for dedicated random access sent via a random access channel.

In some embodiments, referring to FIG. 12, the apparatus further includes a receiving module 1103. The receiving module 1103 is configured to receive a first signaling sent by the network device, and the first signaling instructs the terminal to switch to a model prediction mechanism.

In some embodiments, the first signaling indicates a model identifier of the model; and the first signaling is carried in at least one of: RRC, a medium access control control element (MAC CE), or DCI.

In some embodiments, the model identifier indicates at least one of a model function, a model parameter or a model version of the model.

In some embodiments, referring to FIG. 12, the apparatus further includes a receiving module 1103. The receiving module 1103 is configured to receive a second signaling sent by the network device, and the second signaling includes at least one of: an updated model parameter or an updated model version.

In some embodiments, the sending module 1101 is further configured to input L1-RSRPs and/or L1-SINRs of reference signals in a first set within a second duration into the model to obtain a beam identifier and/or absolute value(s) and/or relative relationships(s) of an L1-RSRP and/or an L1-SINR of an optimal beam within a third duration from reference signals in a second set, where the first set is a subset of the second set.

In some embodiments, the sending module 1101 is further configured to input L1-RSRPs and/or L1-SINRs of reference signals in a third set within a second duration into the model to obtain a beam ID and/or absolute value(s) and/or relative relationships(s) of an L1-RSRP and/or an L1-SINR of an optimal beam within a third duration from reference signals in a fourth set. A beam width of the reference signal in the third set is greater than a beam width of the reference signal in the fourth set, and a beam directional range of each reference signal in the third set covers a beam directional range of a plurality of reference signals in the fourth set.

In some embodiments, the second duration and the third duration are within the same period, or the second duration is a historical duration.

It should be noted that the apparatus according to the above embodiments is illustrated with reference to the division of the above various functional modules as examples when implementing its functions. However, in practical applications, the above functions may be allocated to different functional modules as needed. That is, the internal structure of the device is divided into different functional modules to complete all or part of the functions described above. In addition, the apparatus according to the above embodiments has the same concept as the method embodiments, so its specific implementation processes may refer to the method embodiments, and will not be described again here.

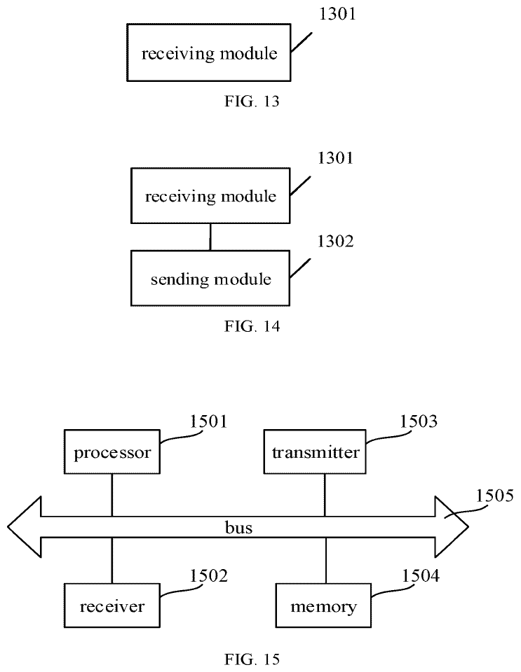

FIG. 13 shows a block diagram of an apparatus for receiving a performance indication according to an example embodiment of the present disclosure, referring to FIG. 13, the apparatus includes a receiving module 1301. The receiving module 1301 is configured to receive the performance indication sent by a terminal, the performance indication is configured to indicate that a performance of a model is higher than a threshold, and the model is used for beam prediction.

In some embodiments, the performance indication includes at least one of:
an indication of good performance of the model;
a performance index value of the model;
at least one of a model identifier, a version identifier, a parameter configuration identifier or parameter configuration of the model; or
at least one of a model identifier, a version identifier, a parameter configuration identifier or parameter configuration of a recommended model.

In some embodiments, the performance indication is sent in a case where the terminal determines that the performance index of the model is higher than the threshold.

In some embodiments, the performance index includes at least one of:
a prediction accuracy;
an average Layer1-reference signal received power (L1-RSRP) difference;
an average Layer1-signal to interference plus noise ratio (L1-SINR) difference;
a target L1-RSRP difference corresponding to a first percentage on a cumulative distribution function (CDF) curve of L1-RSRP differences;
a target L1-SINR difference corresponding to a second percentage on a CDF curve of L1-SINR differences; or
an average UE throughput difference.

In some embodiments, the threshold corresponding to the performance index of the model is determined according to indication information of the network device or a default value.

In some embodiments, referring to FIG. 14, the apparatus further includes a sending module 1302. The sending module 1302 is configured to send the indication information to the terminal, and the indication information includes at least one of: downlink control information (DCI), medium access control control element (MAC CE), or radio resource control (RRC).

In some embodiments, the receiving module 1301 is further configured to:
receive the performance indication sent by the terminal via a physical uplink control channel (PUCCH) or a physical uplink shared channel (PUSCH);
receive the performance indication sent by the terminal via information for carrying channel state information (CSI);
receive the performance indication sent by the terminal via an uplink medium access control control unit (UL MAC CE) and/or a scheduling request (SR); or
receive the performance indication sent by the terminal through a time-frequency domain resource or a preamble for dedicated random access sent via a random access channel.

In some embodiments, referring to FIG. 14, the apparatus further includes a sending module 1302. The sending module 1302 is configured to send a first signaling to the terminal, and the first signaling instructs the terminal to switch to a model prediction mechanism.

In some embodiments, the first signaling indicates a model identifier of the model; and the first signaling is carried in at least one of: RRC, a medium access control control element (MAC CE), or DCI.

In some embodiments, the model identifier indicates at least one of a model function, a model parameter or a model version of the model.

In some embodiments, referring to FIG. 14, the apparatus further includes a sending module 1302. The sending module 1302 is configured to send a second signaling to the terminal, and the second signaling includes at least one of: an updated model parameter or an updated model version.

It should be noted that the apparatus according to the above embodiments is illustrated with reference to the division of the above various functional modules as examples when implementing its functions. However, in practical applications, the above functions may be allocated to different functional modules as needed. That is, the internal structure of the device is divided into different functional modules to complete all or part of the functions described above. In addition, the apparatus according to the above embodiments has the same concept as the method embodiments, so its specific implementation processes may refer to the method embodiments, and will not be described again here.

FIG. 15 shows a schematic structural diagram of a communication device according to an example embodiment of the present disclosure, and the communication device includes: a processor 1501, a receiver 1502, a transmitter 1503, a memory 1504 and a bus 1505.

The processor 1501 includes one or more processing cores, and the processor 1501 is configured to execute various functional applications and information processing by running software programs and modules.

The receiver 1502 and the transmitter 1503 may be implemented as a communication component, and the communication component may be a communication chip.

The memory 1504 is connected to the processor 1501 through the bus 1505.

The memory 1504 may be used to store at least one program code, and the processor 1501 is configured to execute the at least one program code to implement the steps in the above method embodiments.

Furthermore, the communication device may be a terminal or a network device. The memory 1504 may be implemented by any type of volatile or non-volatile storage device, or a combination thereof. The volatile or non-volatile storage device includes, but not limited to: a magnetic or optical disk, an electrically erasable programmable read-only memory (EEPROM), an erasable programmable read-only memory (EPROM), a static random access memory (SRAM), a read-only memory (ROM), a magnetic memory, a flash memory, a programmable read-only memory (PROM).

In example embodiments, there is provided a computer-readable storage medium having stored therein executable program codes that, when loaded and executed by a processor, cause the method for sending a performance indication or the method for receiving a performance indication performed by the communication device according to the above various method embodiments to be implemented.

In example embodiments, there is provided a chip. The chip includes a programmable logic circuit and/or program instructions, and is configured to perform the method for sending a performance indication or the method for receiving a performance indication as described in the above various method embodiments when it is run on a terminal or a network device.

In example embodiments, there is provided a communication system, which includes: a terminal, configured to perform the method for sending a performance indication as described above; and a network device, configured to perform the method for receiving a performance indication as described above.

In example embodiments, there is provided a computer program product that, when executed by a processor of a terminal or a network device, causes the method for sending a performance indication or the method for receiving a performance indication as described in the above various method embodiments to be implemented.

Those of ordinary skill in the art may understand that all or some of the steps for implementing the above embodiments may be completed by hardware, or may be completed by programs instructing relevant hardware. The programs may be stored in a computer-readable storage medium. The above-mentioned storage medium may be a read-only memory, a magnetic disk or an optical disk, etc.

The above describes optional embodiments of the present disclosure and is not intended to limit the present disclosure, and any modifications, equivalent substitutions, improvements, or the like made within the spirit and principle of the present disclosure shall be included in the protection scope of the present disclosure.

1. A method for sending a performance indication, performed by a terminal, comprising:
sending the performance indication to a network device, wherein the performance indication is configured to indicate that a performance of a model is higher than a threshold, and the model is used for beam prediction.

2. The method according to claim 1, wherein the performance indication comprises at least one of:
an indication of good performance of the model;
a performance index value of the model;
at least one of a model identifier, a version identifier, a parameter configuration identifier or parameter configuration of the model; or
at least one of a model identifier, a version identifier, a parameter configuration identifier or parameter configuration of a recommended model.

3. The method according to claim 1, wherein sending the performance indication to the network device comprises:
sending the performance indication to the network device, in a case where it is determined that a performance index of the model is higher than the threshold,
wherein the performance index comprises at least one of:
a prediction accuracy;
an average Laver1-reference signal received power (L1-RSRP) difference:
an average Layer1-signal to interference plus noise ratio (L1-SINR) difference;
a target L1-RSRP difference corresponding to a first percentage on a cumulative distribution function (CDF) curve of L1-RSRP differences;
a target L1-SINR difference corresponding to a second percentage on a CDF curve of L1-SINR differences; or
an average UE throughput difference.

4. (canceled)

5. The method according to claim 3, further comprising:
monitoring the model to obtain the performance index of the model.

6. The method according to claim 5, wherein monitoring the model to obtain the performance index of the model comprises:
determining the performance index according to at least one prediction result output by the model within a first duration; or
determining the performance index according to N1 prediction results output by the model, where N1 is a positive integer.

7-8. (canceled)

9. The method according to claim 1, wherein sending the performance indication to the network device comprises:
reporting the performance indication to the network device via a physical uplink control channel (PUCCH) or a physical uplink shared channel (PUSCH);
reporting the performance indication to the network device via information for carrying channel state information (CSI);
reporting the performance indication to the network device via at least one of an uplink medium access control control unit (UL MAC CE) and/or a scheduling request (SR); or
reporting the performance indication to the network device through a time-frequency domain resource or a preamble for dedicated random access sent via a random access channel.

10. The method according to claim 1, further comprising at least one of:
receiving a first signaling sent by the network device, wherein the first signaling instructs the terminal to switch to a model prediction mechanism or
receiving a second signaling sent by the network device, wherein the second signaling comprises at least one of: an updated model parameter or an updated model version.

11. The method according to claim 10, wherein the first signaling indicates a model identifier of the model; and the first signaling is carried in at least one of: RRC, a medium access control control element (MAC CE), or DCI.

12. The method according to claim 11, wherein the model identifier indicates at least one of a model function, a model parameter or a model version of the model.

13. (canceled)

14. The method according to claim 1 further comprising:
inputting L1-RSRPs L1-SINRs, or both L1-RSRPs and L1-SINRs of reference signals in a first set within a second duration into the model to obtain at least one of a beam identifier, an absolute value of an L1-RSRP, a relative relationship of the L1-RSRP, an absolute value of an L1-SINR, or a relative relationship of the L1-SINRabsolute and/or of an optimal beam within a third duration from reference signals in a second set, wherein the first set is a subset of the second set.

15. The method according to claim 1 further comprising:
inputting L1-RSRPs, L1-SINRs, or both L1-RSRPs and L1-SINRs of reference signals in a third set within a second duration into the model to obtain at least one of a beam identifier, an absolute value of an L1-RSRP, a relative relationship of the L1-RSRP, an absolute value of an L1-SINR, or a relative relationship of the L1-SINR L1-SINR of an optimal beam within a third duration from reference signals in a fourth set, wherein a beam width of the reference signal in the third set is greater than a beam width of the reference signal in the fourth set, and a beam directional range of each reference signal in the third set covers a beam directional range of a plurality of reference signals in the fourth set.

16. (canceled)

17. A receiving method for receiving a performance indication, performed by a network device, comprising:
receiving the performance indication sent by a terminal, wherein the performance indication is configured to indicate that a performance of a model is higher than a threshold, and the model is used for beam prediction.

18. The method according to claim 17, wherein the performance indication comprises at least one of:
an indication of good performance of the model;
a performance index value of the model;
at least one of a model identifier, a version identifier, a parameter configuration identifier or parameter configuration of the model; or
at least one of a model identifier, a version identifier, a parameter configuration identifier or parameter configuration of a recommended model.

19. The method according to claim 17, wherein the performance indication is sent in a case where the terminal determines that the performance index of the model is higher than the threshold,
wherein the performance index comprises at least one of:
a prediction accuracy;
an average Layer1-reference signal received power (L1-RSRP) difference;
an average Layer1-signal to interference plus noise ratio (L1-SINR) difference;
a target L1-RSRP difference corresponding to a first percentage on a cumulative distribution function (CDF) curve of L1-RSRP differences;
a target L1-SINR difference corresponding to a second percentage on a CDF curve of L1-SINR differences; or
an average UE throughput difference.

20-22. (canceled)

23. The method according to claim 17, wherein receiving the performance indication sent by the terminal comprises:
receiving the performance indication sent by the terminal via a physical uplink control channel (PUCCH) or a physical uplink shared channel (PUSCH);
receiving the performance indication sent by the terminal via information for carrying channel state information (CSI);
receiving the performance indication sent by the terminal via at least one of an uplink medium access control control unit (UL MAC CE) and/or a scheduling request (SR); or
receiving the performance indication sent by the terminal through a time-frequency domain resource or a preamble for dedicated random access sent via a random access channel.

24. The method according to claim 17 further comprising at least one of:
sending a first signaling to the terminal, wherein the first signaling instructs the terminal to switch to a model prediction mechanism, or
sending a second signaling to the terminal, wherein the second signaling comprises at least one of: an updated model parameter or an updated model version.

25-29. (canceled)

30. A terminal, comprising:
a processor; and
a transceiver connected to the processor;
wherein the processor is configured to: send an performance indication to a network device, wherein the performance indication is configured to indicate that a performance of a model is higher than a threshold, and the model is used for beam prediction executable indication

31. A network device, comprising:
a processor; and
a transceiver connected to the processor;
wherein the processor is configured to perform the method according to claim 17.

32. (canceled)

33. A computer-readable storage medium having stored therein executable program codes that, when loaded and executed by a processor, cause the processor to perform the method according to claim 1.

34. A non-transitory computer-readable storage medium having stored therein executable program codes that, when loaded and executed by a processor, cause the processor to perform the method according to claim 17.
